(19) United States
(12) Patent Application Publication
(10) Pub. No.: US 2014/0063199 A1
(43) Pub. Date: Mar. 6, 2014

(54) ELECTRONIC DEVICE AND DEPTH CALCULATING METHOD OF STEREO CAMERA IMAGE USING THE SAME

(71) Applicant: SAMSUNG ELECTRO-MECHANICS CO., LTD., Suwon (KR)

(72) Inventor: Joo Hyun KIM, Suwon (KR)

(73) Assignee: Samsung Electro-Mechanics Co., Ltd., Suwon (KR)

(21) Appl. No.: 13/793,504

(22) Filed: Mar. 11, 2013

(30) Foreign Application Priority Data
Sep. 5, 2012 (KR) 10-2012-0098441

(51) Int. Cl. H04N 13/02

(52) U.S. Cl. CPC H04N 13/0239
USPC 348/47

(57) ABSTRACT

There are provided an electronic device and a stereo camera image depth calculating method using the same. The stereo camera image depth calculating method includes: receiving first and second sample images obtained by simultaneously imaging an object with a stereo camera configured of first and second cameras; scanning the first and second sample images to calculate disparities in respective points of the object in a reference direction; and selecting a value equal to or smaller than a minimum value among the calculated disparities as a relative movement value.

### CROSS-REFERENCE TO RELATED APPLICATIONS

This application claims the priority of Korean Patent Application No. 10-2012-0098441 filed on Sep. 5, 2012, in the Korean Intellectual Property Office, the disclosure of which is incorporated herein by reference.

### BACKGROUND OF THE INVENTION

1. Field of the Invention

The present invention relates to an electronic device and a stereo camera image depth calculating method using the same.

2. Description of the Related Art

In order to accurately recognize motion of an object in an image captured using a stereo camera, distances (depths) between the stereo camera and respective points of the object should be calculated.

In order to recognize motion using the camera, a depth camera for calculating image depth has been mainly used. As a typical depth camera for calculating image depth, Microsoft's Kinetic camera, which calculates a depth using a structured infrared (IR) light source, is representative. When Microsoft's Kinetic is used, image depth may be precisely calculated; however, there is a limitation (about 4 m or less) on a depth which the camera is able to calculate, while the outdoor use thereof is impossible.

As a method of solving these problems, there is provided a stereo camera image depth calculating method. In this method, a principle of binocular disparity of a specific pixel in images input from two cameras is used.

The maximum number of pixels in an image of a depth calculating camera using a currently introduced stereo camera is a VGA level (640*480). However, in order to precisely calculate depth like Microsoft's Kinetic, the number of pixels in an image should be increased to a high definition (HD) level (1280*720) or more. However, in this case, a rapid increase in a calculation amount required for calculating image depth is caused.

In order to calculate image depth using the stereo camera having the number of pixels corresponding to the VGA level, it is required to search where a specific portion of a left image that becomes a reference is present in aright image. In this case, the search is generally performed from a current position up to a position next to 64 pixels. However, when the number of pixels of the camera is increased to the HD level, since the number of horizontal pixels is increased two times as compared with the VGA level, the number of search pixels should be 128 or more, which means a rapid increase in a calculation amount.

Therefore, it has been required to implement a method capable of not increasing a calculation amount required for calculating image depth by decreasing a search range of pixels.

### SUMMARY OF THE INVENTION

An aspect of the present invention provides a method capable of improving depth (distance) calculation precision without increasing a data throughput (calculation amount) in calculating image depth of a stereo camera image using an electronic device.

According to an aspect of the present invention, there is provided a stereo camera image depth calculating method, including: receiving first and second sample images obtained by simultaneously imaging an object with a stereo camera configured of first and second cameras; scanning the first and second sample images to calculate disparities in respective points of the object in a reference direction; and selecting a value equal to or smaller than a minimum value among the calculated disparities as a relative movement value.

The stereo camera image depth calculating method may further include: selecting regions of interest in first and second images obtained by simultaneously imaging the object with the stereo camera configured of the first and second cameras; relatively moving the regions of interest of the first and second images in the reference direction by the relative movement value so that the disparities are decreased; scanning the regions of interest relatively moved in the first and second images to calculate corrected disparities in respective points in the reference direction; and adding the relative movement value to the corrected disparities to calculate original disparities in respective points.

The stereo camera image depth calculating method may further include: relatively moving first and second images obtained by simultaneously imaging the object with the stereo camera configured of the first and second cameras in the reference direction by the relative movement value so that the disparities are decreased; scanning a region in which the relatively moved first and second images are overlapped with each other in the reference direction to calculate corrected disparities in respective points in the reference direction; and adding the relative movement value to the corrected disparities to calculate original disparities in respective points.

The stereo camera image depth calculating method may further include calculating distances (depths) of respective points of the object using the calculated original disparities.

The depths of respective points may be depths from a base line connecting the first and second cameras to each other to respective points of the object.

The regions of interest may be the same region as each other in the first and second images.

The regions of interest may be regions including a dynamic target of the object in the first and second images.

The overlapped region may be a region including a dynamic target of the object in the first and second images.

The relative movement value may be a minimum value among the calculated disparities.

The reference direction may be a direction from the first camera toward the second camera or a direction parallel to an opposite direction thereto.

In the receiving of the first and second sample images, a plurality of first and second images obtained by simultaneously imaging the object with the stereo camera configured of the first and second cameras may be received, and the simultaneously imaged first and second sample images among the plurality of first and second images may be selected and received.

The calculating of the disparities in respective points of the object in the reference direction may be performed on the selected regions in the first and second sample images.

According to another aspect of the present invention, there is provided an electronic device including: a user inputting unit receiving a plurality of first and second images simultaneously captured by a stereo camera; a memory storing the received first and second images therein; and a controlling unit selecting first and second sample images from among the first and second images, scanning the selected first and second sample images to calculate disparities in respective points of an object in a reference direction, and selecting a value equal to or smaller than a minimum value among the calculated disparities as a relative movement value.

The controlling unit may select regions of interest in the first and second images, relatively move the regions of interest in the reference direction by the relative movement value so that the disparities are decreased, scan the relatively moved regions of interest to calculate corrected disparities in respective points in the reference direction, and add the relative movement value to the corrected disparities to calculate original disparities in respective points.

The controlling unit may relatively move the first and second images in the reference direction by the relative movement value so that the disparities are decreased, scan a region in which the relatively moved first and second images are overlapped with each other in the reference direction to calculate corrected disparities in respective points in the reference direction, and add the relative movement value to the corrected disparities to calculate original disparities in respective points.

The controlling unit may calculate distances (depths) of respective points of the object using the calculated original disparities.

The electronic device may further include an outputting unit outputting the depths of respective points calculated by the controlling unit.

The outputting unit may be a display unit outputting a result on a screen.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing an electronic device according to an embodiment of the present invention;

FIGS. 2 and 3 are flowcharts showing a stereo camera image depth calculating method using the electronic device according to the embodiment of the present invention;

FIG. 4 is a reference diagram illustrating a disparity calculating method using a sample image according to the embodiment of the present invention;

FIG. 5 is a reference diagram illustrating a disparity calculating method of an image according to the embodiment of the present invention;

FIG. 6 is a reference diagram showing a state after selecting a region of interest from an image and relatively moving the region of interest according to the embodiment of the present invention;

FIG. 7 is a reference diagram showing a state after relatively moving the image according to the embodiment of the present invention; and

FIGS. 8A and 8B are reference diagrams illustrating a mathematical calculating method for calculating image depth according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components maybe exaggerated for clarity, and the same reference numerals will be used throughout to designate the same or like components.

An electronic device described in the present specification may include a computer (including both of a desktop computer and a laptop computer), a cellular phone, a smart phone, a personal digital assistant (PDA), a portable multimedia player (PMP), and the like. In addition, the electronic device may include all of the electronic devices connected to a stereo camera described in an embodiment of the present invention and including a controlling unit.

Further, it may be easily appreciated by those skilled in the art that a configuration according to an embodiment of the present invention described in the present specification may be applied to a fixed electronic device such as a desktop computer, or the like, as well as a portable electronic device.

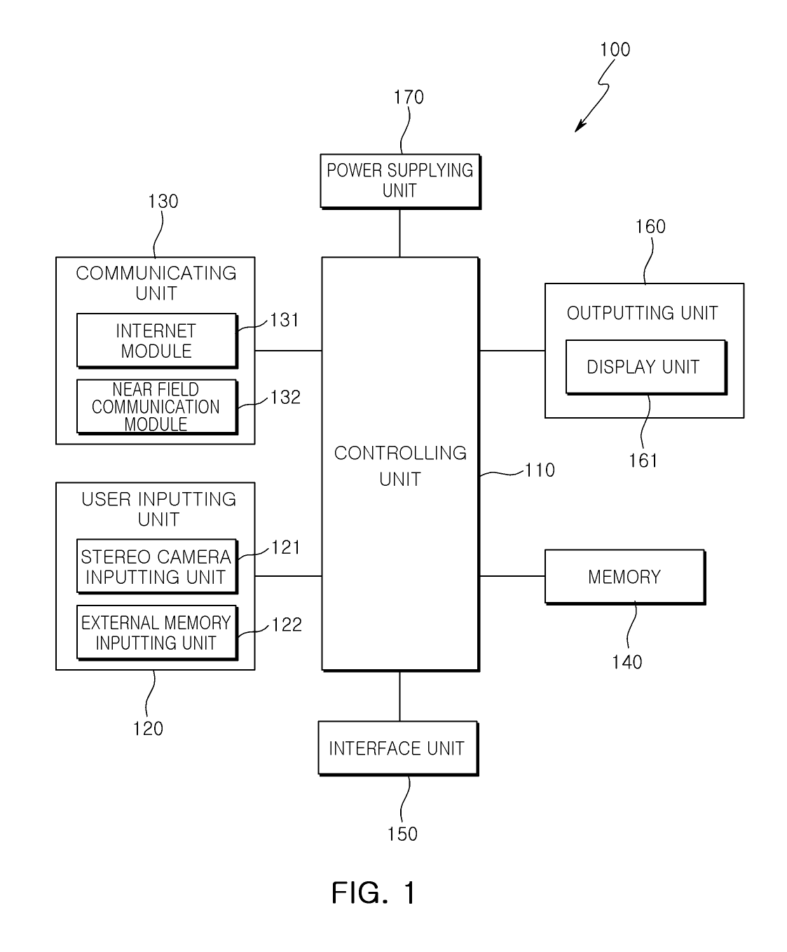

FIG. 1 is a block diagram showing an electronic device according to an embodiment of the present invention.

Referring to FIG. 1, an electronic device 100 according to the embodiment of the present invention may include a controlling unit 110, a user inputting unit 120, a communicating unit 130, a memory 140, an outputting unit 160, and a power supplying unit 170. The components shown in FIG. 1 are not essential components. Therefore, the electronic device may also be implemented to have components more or less than the components shown in FIG. 1.

The controlling unit 110 may generally control a general operation of the electronic device. For example, the controlling unit 110 may select a region of interest from an input image or perform associated control and processing for calculation of a disparity, or the like. More specifically, the controlling unit 110 may perform control and processing associated with an operation command that may be executed in depth calculation of a stereo camera image to be described below.

In addition, the controlling unit 110 may generate the operation command corresponding to an input of a user. The controlling unit 110 may also include a multimedia module (not shown) for reproducing a multimedia. The multimedia module may be implemented in the controlling unit 110 or be implemented separately from the controlling unit 110. Further, in the case in which contents stored in a memory are changed, the controlling unit 110 may apply all of these contents to each component.

The user inputting unit 120 may be used for the user to generate input data for controlling an operation of the electronic device. The user inputting unit 120 may be configured of a keypad, a dome switch, a (resistive/capacitive) touch pad, a jog wheel, a jog switch, or the like. In addition, the user inputting unit 120 may receive first and second images captured by a stereo camera or first and second sample images.

In addition, the user inputting unit 120 may include at least one of a stereo camera inputting unit 121 and an external memory inputting unit 122. The user inputting unit 120 may directly receive the image captured by the stereo camera through the stereo camera inputting unit 121.

Alternatively, the user inputting unit may receive the image captured by the stereo camera through the external memory inputting unit 122 through a medium of an external memory, or the like.

The communicating unit 130 may include at least one module enabling communication between the electronic device 100 and a communication system or between the electronic device 100 and a network in which the electronic device 100 is positioned. The communicating unit 130 may perform communication in a wired or wireless scheme. For example, the communicating unit 130 may include the Internet module 131, a short range communication module 132, and the like.

The communicating unit 130 may perform the communication with the stereo camera in the wired or wireless scheme using the Internet module 131 or the short range communication module 132. Therefore, the first and second images captured by the stereo camera or the first and second sample images may be received through the communicating unit 130 and be input to the user inputting unit 120 through the controlling unit 110.

Alternatively, distances (depths) of respective points calculated in the electronic device 100 may be transmitted to another electronic device, or the like, through the communicating unit 130.

The Internet module 131, which indicates a module for wired or wireless Internet access, may be disposed inside or outside the electronic device 100. As the Internet technology, a local area network (LAN) technology, a wireless LAN (WLAN) (Wi-Fi) technology, a wireless broadband (Wibro) technology, a world interoperability for microwave access (Wimax) technology, a high speed downlink packet access (HSDPA) technology, or the like, may be used.

The near field communication module 132 indicates a module for near field communications. As a representative near field communications technology, Bluetooth technology, a radio frequency identification (RFID) technology, an infrared data association (IrDA) technology, an ultra wideband (UWB) technology, a ZigBee technology, or the like, may be used.

The memory 140 may store a program for an operation of the controlling unit 110 therein and temporally or permanently store input/output and calculated data (results) (for example, a still image, a moving picture, a disparity, a phonebook, a message, or the like) therein. The memory 140 may store an image content input or selected from the user therein. The memory 140 may include at least one of a flash memory type storage medium, a hard disk type storage medium, a multimedia card micro type storage medium, a card type memory (for example, an SD or XD memory, or the like), a random access memory (RAM), a static random access memory (SRMA), a read-only memory (ROM), an electrically erasable programmable read-only memory (EEPROM), a programmable read-only memory (PROM), a magnetic memory, a magnetic disk, and an optical disk. The electronic device 100 may also be operated in connection with a web storage performing a function of storing the memory 140 on the Internet.

The interface unit 150 serves as a path with all external devices connected to the electronic device 100. The interface unit 150 may receive data or power transmitted or supplied from an external device to transfer the data or the power to each component in the electronic device 100 or allow data in the electronic device 100 to be transmitted to the external device. The interface unit 150 may include, for example, a wired/wireless headset port, an external charger port, a wired/wireless data port, a memory card port, a port for connection to a device including an identity module, an audio input/output (I/O) port, a video I/O port, an earphone port, and the like.

The outputting unit 160, which is to generate an output associated with a view, may include a display unit 161, and the like.

The display unit 161 may display (output) information processed in the electronic device 100. For example, in the case in which calculation of distances (depths) of respective points for the image is completed in the controlling unit, the results may be displayed on the display unit.

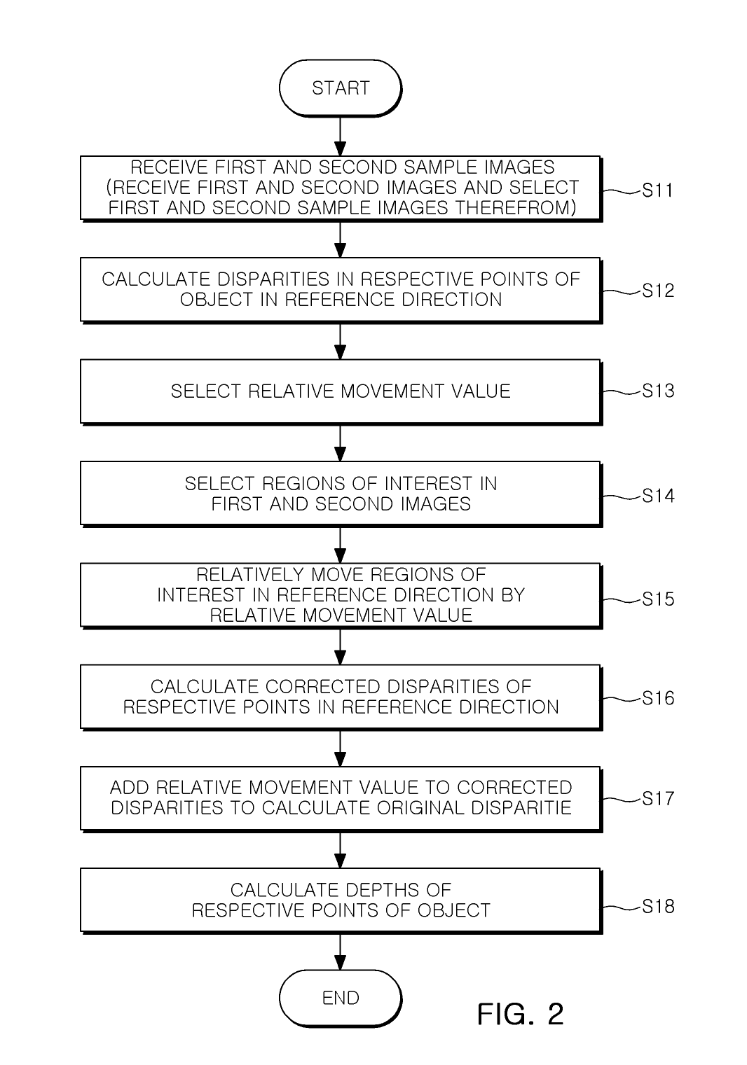

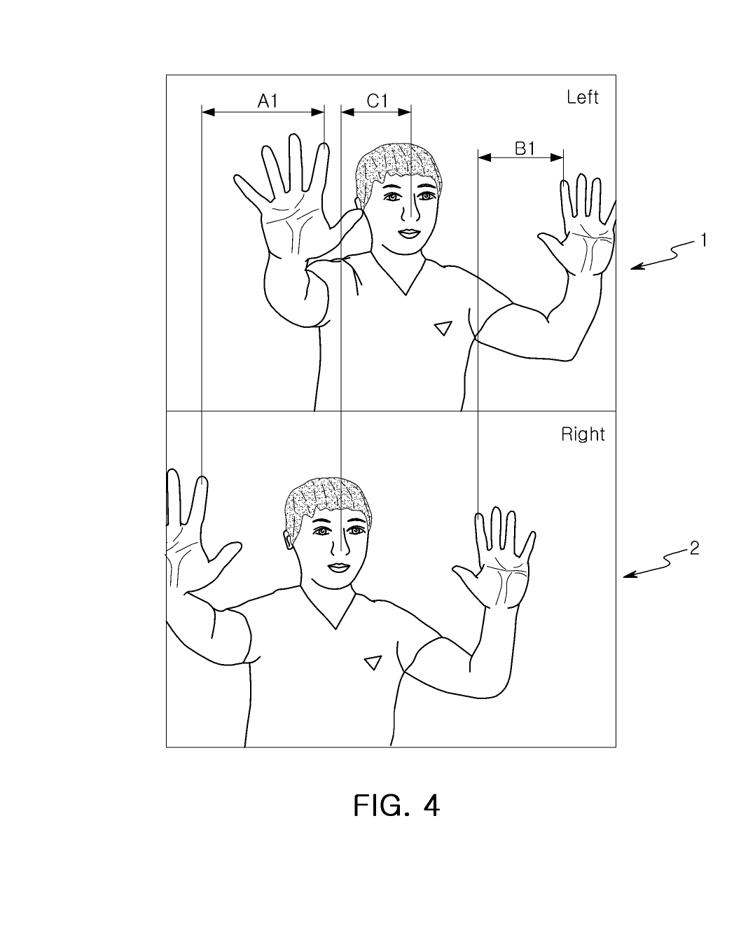

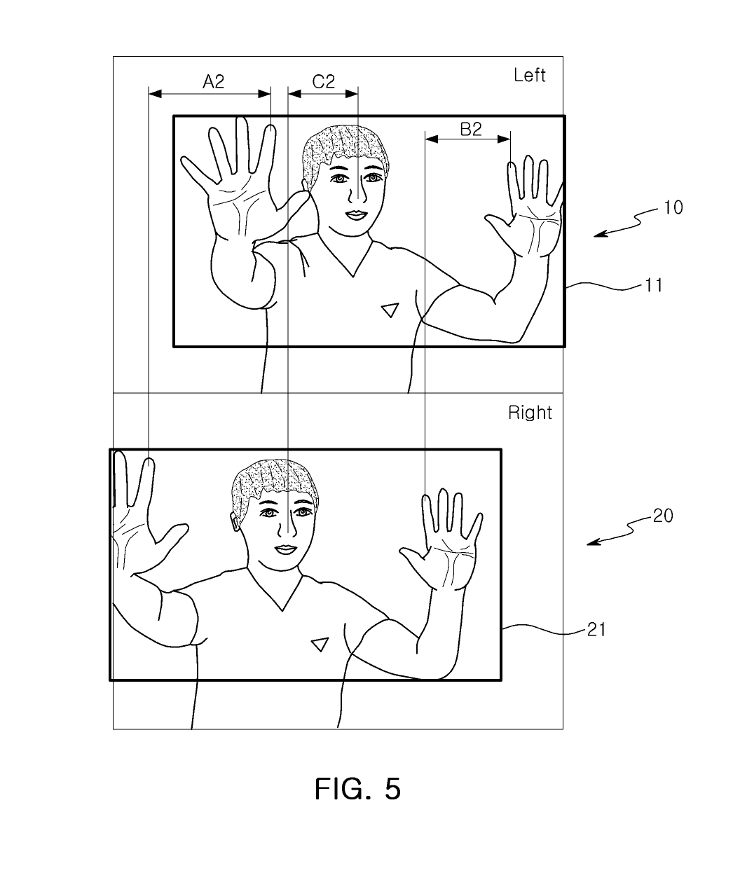

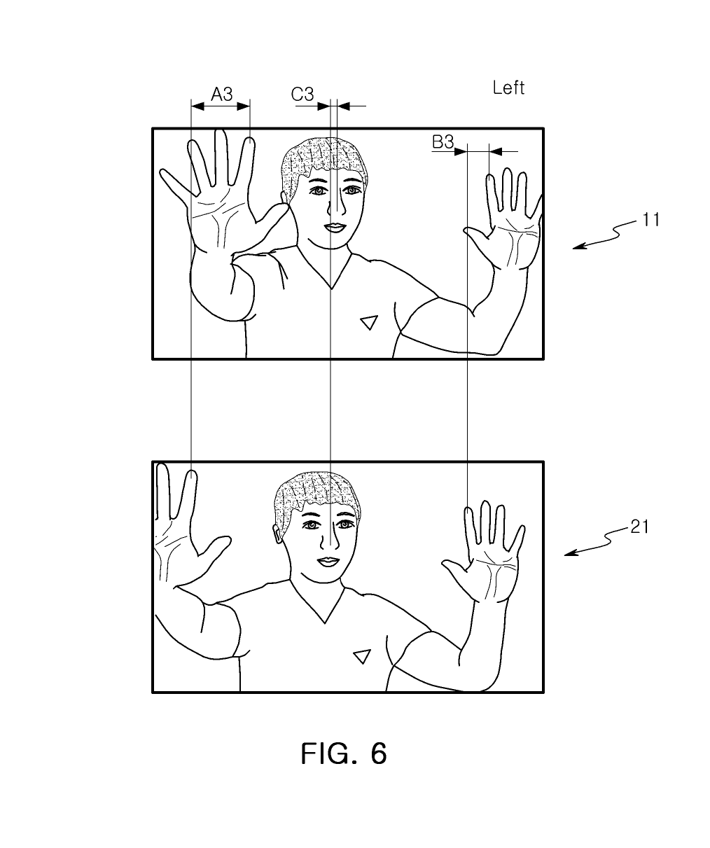

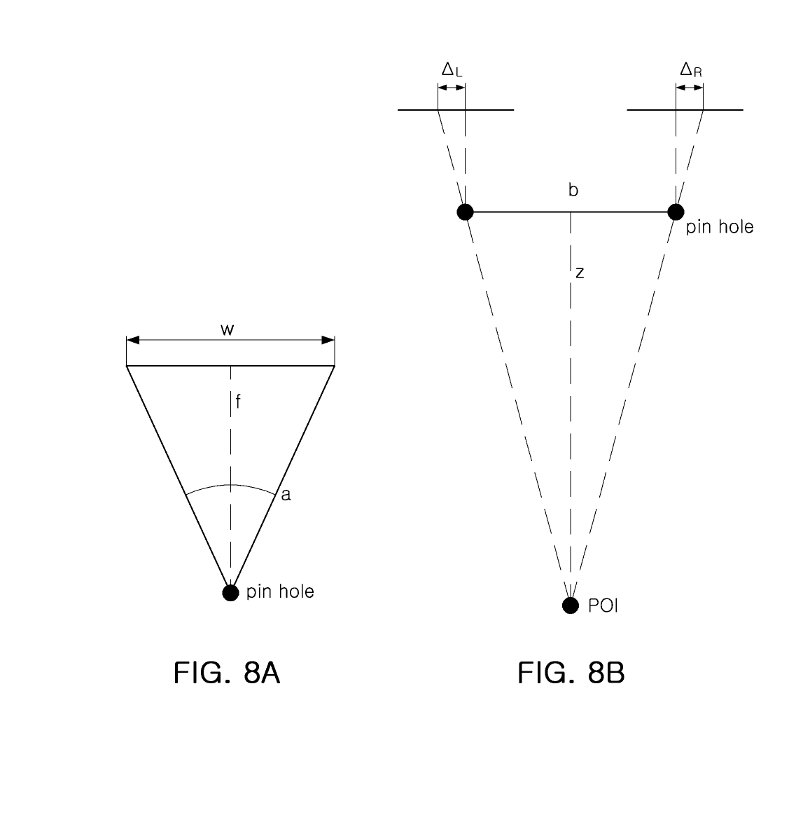

FIG. 2 is a flowchart showing a stereo camera image depth calculating method using the electronic device according to the embodiment of the present invention; FIG. 4 is a reference diagram illustrating a disparity calculating method using a sample image according to the embodiment of the present invention; FIG. 5 is a reference diagram illustrating a disparity calculating method of an image according to the embodiment of the present invention; FIG. 6 is a reference diagram showing a state after selecting a region of interest from an image and relatively moving the region of interest according to the embodiment of the present invention; and FIGS. 8A and 8B are reference diagrams illustrating a mathematical calculating method for calculating image depth according to the embodiment of the present invention.

Referring to FIG. 2, with the stereo camera image depth calculating method according to the embodiment of the present invention, the electronic device 100 may receive a plurality of first and second images captured by the stereo camera including first and second cameras and select first and second sample images from the plurality of first and second images (S11). The electronic device 100 may only receive the first and second sample images. In addition, the electronic device 100 may scan the received first and second sample images to calculate disparities in respective points of an object, particularly, a dynamic object in a reference direction (S12). Then, the electronic device 100 may select a value smaller than or equal to a minimum value among the disparities calculated in the reference direction as a relative movement value (S13).

Next, the electronic device 100 may select regions of interest from each of the first and second images including the object of which the depth is to be calculated and simultaneously captured (S14). Thereafter, the electronic device 100 may relatively move the regions of interest of the first and second images in the reference direction by the relative movement value so that the disparities are decreased (S15). Then, the regions of interest relatively moved in the first and second images may be scanned to calculate corrected disparities in respective points in the reference direction (S16). Next, the relative movement value may be added to the corrected disparities to calculate original disparities in respective points (S17). Thereafter, finally, distances (depths) of respective points of the object may be calculated using the calculated original disparities (S18).

Hereinafter, the stereo camera image depth calculating method according to the embodiment of the present invention will be described in detail with reference to FIGS. 2, 4 through 6, 8A and 8B.

As shown in FIGS. 4 through 6, in the stereo camera image depth calculating method according to the embodiment of the present invention, a plurality of first and second images 10 and 20 obtained by simultaneously imaging the object with the stereo camera configured of the first and second cameras may be input (S11). In addition, the first and second sample images 1 and 2 among the plurality of received first and second images 10 and 20 may be selected (S11). However, only the first and second sample images 1 and 2 rather than the plurality of first and second images 10 and 20 may be input.

The reason why the first and second sample images 1 and 2 are selected from the plurality of first and second images 10 and 20 or only the first and second sample images 1 and 2 are input and a minimum disparity is calculated by calculating the disparities in respective points of the first and second sample images 1 and 2 is to decrease a data throughput. That is, a scheme of calculating the minimum disparity in the sample images and applying the minimum disparity as a reference disparity to all the images including the sample images is used. That is, in the case in which individual disparities are calculated by scanning all the images, a scan amount is very large and the number of points at which the disparities are to be calculated is very large, such that a data throughput may be exponentially increased. Therefore, according to the embodiment of the present invention, the minimum disparity may be calculated in the sample images, and the first and second images may be relatively moved by a value equal to or smaller than the calculated minimum disparity, and the scan and disparity calculation thereof may only be performed on the selected regions of interest in the first and second images.

The first and second cameras included in the stereo camera may have the same function and performance. Therefore, the plurality of first and second images 10 and 20 may have the same pixels at the same size and be different only in a direction in which they are imaged. Therefore, in the first and second images 10 and 20, the disparities may be generated in respective points.

Generally, the disparities may be generated in a horizontal direction in that the first and second cameras in the stereo camera are disposed in the horizontal direction. More specifically, the disparities may be generated in a direction from the first camera toward the second camera or an opposite direction thereto.

As shown in FIGS. 4 through 6, it could be appreciated that the disparities are generated with respect to specific points in images 1, 10, and 11 captured by the first camera and disposed at an upper portion and images 2, 20, and 21 captured by the second camera and disposed at a lower portion, and the disparities in respective points may be different from each other. That is, it could be appreciated that the disparities of A1, B1, and C1 in the case of FIGS. 4, A2, B2, and C2 in the case of FIGS. 5, and A3, B3, and C3 in the case of FIG. 6 are generated in each of the three points and the disparities in respective points are different from each other.

Next, the first and second sample images 1 and 2 may be scanned to calculate the disparities in respective points of the object in the reference direction. That is, as shown in FIG. 4, it could be appreciated that the disparities A1, B1, and C1 in each of the three points in the reference direction are differently calculated.

The disparities A1, B1, and C1 may be calculated by a physical method. That is, an actual distance (depth) may be measured using a rule, or the like, or the number of pixels on a display screen may be detected and a depth may be calculated from the number of pixels. Various schemes other than the above-mentioned scheme may be used.

Next, a value equal to or smaller than the minimum value among the calculated disparities A1, B1, and C1 may be selected as a relative movement value. The first and second images need to be relatively moved in a limitation of the minimum value among a plurality of disparities calculated in respective points in order to prevent a negative disparity from being generated after the relative movement. That is, this is to prevent the negative disparity from being generated when one direction of the disparity is considered as a positive (+) direction. This is to facilitate the calculation.

Meanwhile, in the case in which the minimum value among the calculated disparities is selected as the relative movement value, points at which the minimum value is calculated after relatively moving the first and second images may be disposed on the same position on the first and second images in the reference direction.

Further, the calculation of the disparities in respective points of the object in the reference direction may be performed on the selected regions in the first and second sample images. This is to further decrease a data throughput.

Next, the regions of interest 11 and 21 may be selected from the first and second images 10 and 20, respectively (S14). In order to accomplish an object of the present invention that is to decrease the data throughput in calculating the stereo camera image depth, the regions of interest 11 and 21 may be selected from the first and second images 10 and 20, respectively, and the scan and calculation may be only performed on the selected regions of interest 11 and 21.

The regions of interest 11 and 21 may be the same region in the first and second images 10 and 20. However, since the first and second images captured by the first and second cameras are not same as each other, the regions of interest 11 and 21 may be selected by setting a range including the approximately same object, particularly, a dynamic target. In FIG. 5, since only a person among a plurality of objects is a dynamic target, regions corresponding thereto have been selected as the regions of interest 11 and 21.

Next, the regions of interest 11 and 21 of the first and second images may be relatively moved in the reference direction by the relative movement value so that the disparities are decreased (S15). Then, the regions of interest 11 and 21 relatively moved in the first and second images may be scanned to calculate the corrected disparities A3, B3, and C3 in respective points in the reference direction (S16).

Referring to FIG. 6, it could be appreciated that the regions of interest 11 and 21 of the first and second images are disposed on the same position so as to be overlapped with each other in the reference direction. In addition, it could be appreciated that after the regions of interest 11 and 21 of the first and second images are relatively moved, the corrected disparities A3, B3, and C3 in respective points become smaller than the original disparities A2, B2, and C2 before the regions of interest 11 and 21 of the first and second images are relatively moved.

That is, in the case in which the controlling unit scans the regions of interest 11 and 21 of the first and second images, since the same points are found at positions closer to each other in the regions of interest 11 and 21 of the first and second images in respective points, a scan amount may be decreased. Further, since the regions of interest 11 and 21 selected to include the dynamic target has a size smaller than that of an actual image, the scan amount may be decreased.

The corrected disparities A3, B3, and C3 may be calculated by a physical method. That is, an actual distance (depth) maybe measured using a rule, or the like, or the number of pixels on a display screen may be detected and a depth may be calculated from the number of pixels. Various schemes other than the above-mentioned scheme may be used.

Next, the relative movement value may be added to the corrected disparities A3, B3, and C3 to calculate the original disparities A2, B2, and C2 in respective points (S17). Since the regions of interest 11 and 21 of the first and second images have been relatively moved by the relative movement value in a direction in which the disparities are decreased, the relative movement value may be added to the corrected disparities A3, B3, and C3 in order to calculate the original disparities A2, B2, and C2.

Next, the depths of respective points of the object may be calculated using the calculated original disparities A2, B2, and C2 (S18). The depths of respective points may be depths from a base line connecting the first and second cameras to each other to respective points of the object (POI).

Referring to FIGS. 8A and 8B, the depth according to the embodiment of the present invention may be calculated. Referring to FIG. 8A, a focal length (f) of a camera lens may be calculated by the following Equation 1.

$$f = \frac{w}{2 tan ( \frac{a}{2} )} \qquad [ Equation 1 ]$$

where f indicates a focal length of a lens, w indicates a horizontal resolution, a indicates a horizontal view angle of a lens, and pin hole indicates a frontmost end lens surface in an object direction.

Next, referring to FIG. 8B, a depth (Z) in respective points may be calculated by the following proportional Equation 1 and the following Equation 2.

D:f=b:Z [Proportional Equation 1]

$$Z = \frac{f b}{D} = \frac{w b}{2 tan ( \frac{a}{2} ) D} \qquad [ Equation 2 ]$$

where Z indicates a depth from the base line to an object, D indicates a disparity (Δ_{L}+Δ_{R}), ΔL indicates a disparity of a first camera, Δ_{R} indicates a disparity of a second camera, and b indicates a length of a base line connecting the first and second cameras to each other.

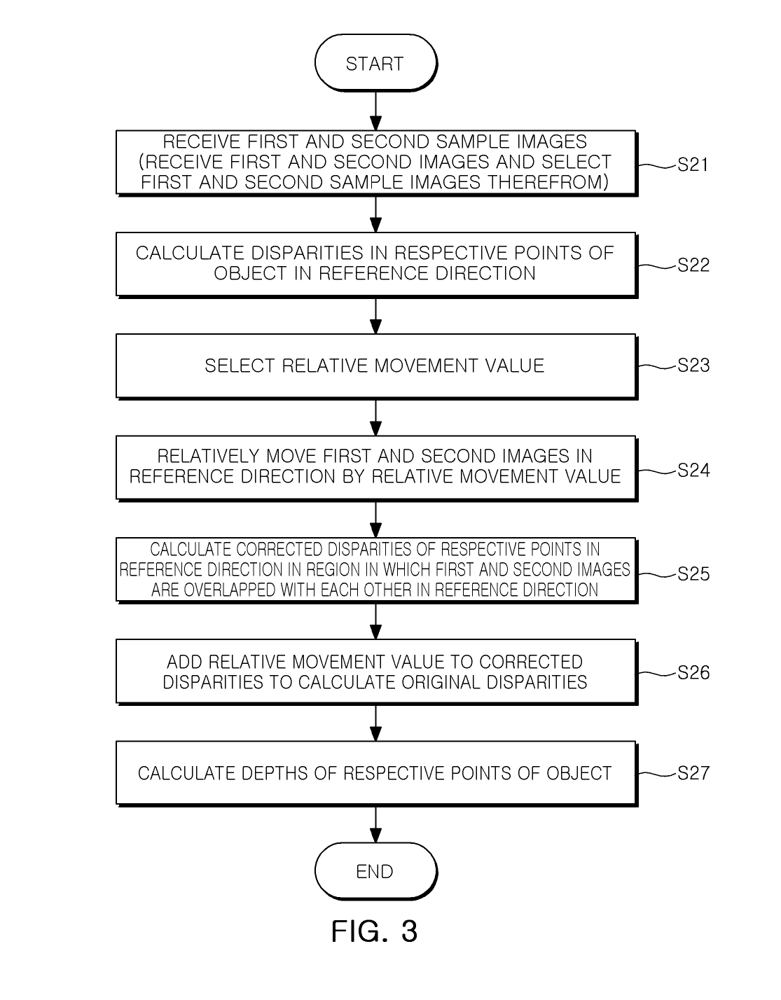

Next, a stereo camera image depth calculating method according to another embodiment of the present invention will be described with reference to FIGS. 3 through 5, 7, 8A and 8B.

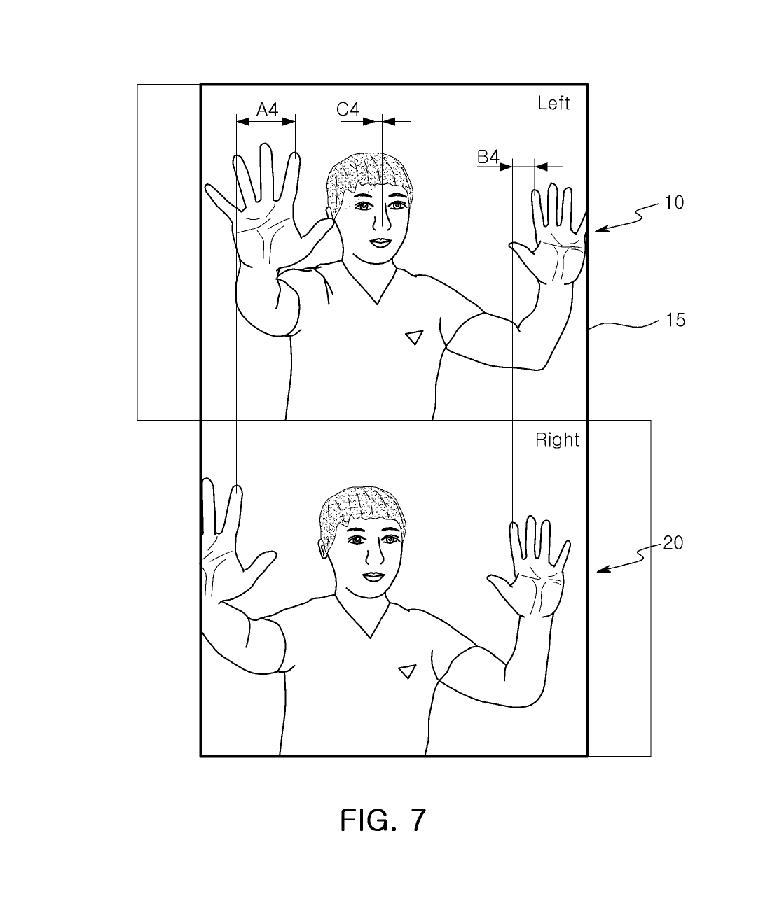

FIG. 3 is a flowchart showing a stereo camera image depth calculating method using the electronic device according to the embodiment of the present invention; FIG. 4 is a reference diagram illustrating a disparity calculating method using a sample image according to the embodiment of the present invention; FIG. 5 is a reference diagram illustrating a disparity calculating method of an image according to the embodiment of the present invention; FIG. 7 is a reference diagram showing a state after relatively moving the image according to the embodiment of the present invention; and FIGS. 8A and 8B are reference diagrams illustrating a mathematical calculating method for calculating image depth according to the embodiment of the present invention.

Referring to FIG. 3, with the stereo camera image depth calculating method according to another embodiment of the present invention, the electronic device 100 may receive a plurality of first and second images captured by the stereo camera including the first and second cameras and select first and second sample images from the plurality of first and second images (S21). The electronic device 100 may only receive the first and second sample images. In addition, the electronic device 100 may scan the received first and second sample images to calculate disparities in respective points of an object, particularly, a dynamic object in a reference direction (S22). Then, the electronic device 100 may select a value smaller than or equal to a minimum value among the disparities calculated in the reference direction as a relative movement value (S23).

Thereafter, the electronic device 100 may relatively move the first and second images in the reference direction by the relative movement value so that the disparities are decreased (S24). Then, a region in which the first and second images are overlapped with each other in the reference direction may be scanned to calculate corrected disparities in respective points in the reference direction (S25). Next, the relative movement value may be added to the corrected disparities to calculate original disparities in respective points (S26). Thereafter, finally, distances (depths) of respective points of the object may be calculated using the calculated original disparities (S27).

Hereinafter, the stereo camera image depth calculating method according to another embodiment of the present invention will be described in detail with reference to FIGS. 3 through 5, 7, 8A and 8B.

As shown in FIGS. 4, 5, and 7, in the stereo camera image depth calculating method according to another embodiment of the present invention, a plurality of first and second images 10 and 20 obtained by simultaneously imaging the object with the stereo camera configured of the first and second cameras may be input (S21). In addition, the first and second sample images 1 and 2 among the plurality of first and second images 10 and 20 may be selected (S21). However, only the first and second sample images 1 and 2 rather than the plurality of first and second images 10 and 20 may be input.

The reason why the first and second sample images 1 and 2 are selected from the plurality of first and second images 10 and 20 or only the first and second sample images 1 and 2 are input and a minimum disparity is obtained by calculating the disparities in respective points of the first and second sample images 1 and 2 is to decrease a data throughput. That is, a scheme of calculating the minimum disparity in the sample images and applying the minimum disparity as a reference disparity to all the images including the sample images is used. That is, in the case in which individual disparities are calculated by scanning all the images, a scan amount is very large and the number of points at which the disparities are to be calculated is very large, such that a data throughput may be exponentially increased. Therefore, according to another embodiment of the present invention, the minimum disparity may be calculated in the sample images, and the first and second images may be relatively moved by a value equal to or smaller than the calculated minimum disparity, and the scan and disparity calculation may only be performed on the region in which the first and second images are overlapped with each other in the reference direction.

The first and second cameras in the stereo camera may have the same function and performance. Therefore, the plurality of first and second images 10 and 20 may have the same pixels at the same size and be only different in a direction in which they are imaged. Therefore, in the first and second images 10 and 20, the disparities may be generated in respective points.

Generally, the disparities may be generated in a horizontal direction in that the first and second cameras in the stereo camera are disposed in the horizontal direction. More specifically, the disparities may be generated in a direction from the first camera toward the second camera or an opposite direction thereto.

As shown in FIGS. 4, 5 and 7, it could be appreciated that the disparities are generated with respect to specific points in images 1 and 10 captured by the first camera and disposed at an upper portion and images 2 and 20 captured by the second camera and disposed at a lower portion, and the disparities in respective points may be different from each other. That is, it could be appreciated that the disparities of A1, B1, and C1 in the case of FIGS. 4 and A4, B4 and C4 in the case of FIG. 7 are generated in each of the three points and the disparities in respective points are different from each other.

Next, the first and second sample images 1 and 2 may be scanned to calculate the disparities in respective points of the object in the reference direction. That is, as shown in FIG. 4, it could be appreciated that the disparities A1, B1, and C1 in each of the three points in the reference direction are differently calculated.

The disparities A1, B1, and C1 may be calculated by a physical method. That is, an actual distance (depth) may be measured using a rule, or the like, or the number of pixels on a display screen may be detected and a depth may be calculated from the number of pixels. Various schemes other than the above-mentioned scheme may be used.

Next, a value equal to or smaller than the minimum value among the calculated disparities A1, B1, and C1 may be selected as a relative movement value. The first and second images need to be relatively moved in a limitation of the minimum value among a plurality of disparities calculated in respective points in order to prevent a negative disparity from being generated after the relative movement. That is, this is to prevent the negative disparity from being generated when one direction of the disparity is considered as a positive (+) direction. This is to facilitate the calculation.

Meanwhile, in the case in which the minimum value among the calculated disparities is selected as the relative movement value, points at which the minimum value is calculated after relatively moving the first and second images may be disposed on the same position on the first and second images in the reference direction.

Further, the calculation of the disparities in respective points of the object in the reference direction may be performed on the selected regions in the first and second sample images. This is to further decrease a data throughput.

Next, the first and second images 10 and 20 may be relatively moved in the reference direction by the relative movement value so that the disparities are decreased (S24). In addition, a region 15 at which the relatively moved first and second images 10 and 20 are overlapped with each other in the reference direction may be scanned to calculate the corrected disparities A4, B4, and C4 in respective points in the reference direction (S25).

Referring to FIG. 7, it could be appreciated that part of the first and second images 10 and 20 are disposed so as to be overlapped with each other in the reference direction. In addition, it could be appreciated that after the first and second images 10 and 20 are relatively moved, the corrected disparities A4, B4, and C4 in respective points become smaller than the original disparities A2, B2, and C2 before the first and second images 10 and 20 are relatively moved.

That is, in the case in which the controlling unit scans the region in which the first and second images 10 and 20 are overlapped with each other in the reference direction, since the same points are found at positions closer to each other in the first and second images 10 and 20 in respective points, a scan amount may be decreased. Further, since the overlapped region 15 selected to include the dynamic target has a size smaller than that of an actual image, the scan amount may be decreased.

The corrected disparities A4, B4, and C4 may be calculated by a physical method. That is, an actual distance (depth) maybe measured using a rule, or the like, or the number of pixels on a display screen may be detected and a depth may be calculated from the number of pixels. Various schemes other than the above-mentioned scheme may be used.

Next, the relative movement value may be added to the corrected disparities A4, B4, and C4 to calculate the original disparities A2, B2, and C2 in respective points (S26). Since the first and second images 10 and 20 have been relatively moved by the relative movement value in a direction in which the disparities are decreased, the relative movement value may be added to the corrected disparities A4, B4, and C4 in order to calculate the original disparities A2, B2, and C2.

Next, the depths of respective points of the object may be calculated using the calculated original disparities A2, B2, and C2 (S27). The depths of respective points may be depths from a base line connecting the first and second cameras to each other to respective points of the object (POI).

The depths of respective points may be calculated in the same scheme as the scheme described with reference to FIG. 8. Therefore, the depths of respective points may be calculated by the above Equation 2.

As set forth above, according to embodiments of the present invention, a method capable of improving depth (distance) calculation precision without increasing a data throughput (calculation amount) in calculating image depth of a stereo camera image using an electronic device may be provided.

While the present invention has been shown and described in connection with the embodiments, it will be apparent to those skilled in the art that modifications and variations can be made without departing from the spirit and scope of the invention as defined by the appended claims.

What is claimed is:

1. A stereo camera image depth calculating method, comprising:
receiving first and second sample images obtained by simultaneously imaging an object with a stereo camera configured of first and second cameras;
scanning the first and second sample images to calculate disparities in respective points of the object in a reference direction; and
selecting a value equal to or smaller than a minimum value among the calculated disparities as a relative movement value.

2. The stereo camera image depth calculating method of claim 1, further comprising:
selecting regions of interest in first and second images obtained by simultaneously imaging the object with the stereo camera configured of the first and second cameras;
relatively moving the regions of interest of the first and second images in the reference direction by the relative movement value so that the disparities are decreased;
scanning the regions of interest relatively moved in the first and second images to calculate corrected disparities in respective points in the reference direction; and
adding the relative movement value to the corrected disparities to calculate original disparities in respective points.

3. The stereo camera image depth calculating method of claim 1, further comprising:
relatively moving first and second images obtained by simultaneously imaging the object with the stereo camera configured of the first and second cameras in the reference direction by the relative movement value so that the disparities are decreased;
scanning a region in which the relatively moved first and second images are overlapped with each other in the reference direction to calculate corrected disparities in respective points in the reference direction; and
adding the relative movement value to the corrected disparities to calculate original disparities in respective points.

4. The stereo camera image depth calculating method of claim 2, further comprising calculating distances (depths) of respective points of the object using the calculated original disparities.

5. The stereo camera image depth calculating method of claim 4, wherein the depths of respective points are depths from a base line connecting the first and second cameras to each other to respective points of the object.

6. The stereo camera image depth calculating method of claim 2, wherein the regions of interest are the same region as each other in the first and second images.

7. The stereo camera image depth calculating method of claim 2, wherein the regions of interest are regions including a dynamic target of the object in the first and second images.

8. The stereo camera image depth calculating method of claim 3, wherein the overlapped region is a region including a dynamic target of the object in the first and second images.

9. The stereo camera image depth calculating method of claim 1, wherein the relative movement value is a minimum value among the calculated disparities.

10. The stereo camera image depth calculating method of claim 1, wherein the reference direction is a direction from the first camera toward the second camera or a direction parallel to an opposite direction thereto.

11. The stereo camera image depth calculating method of claim 1, wherein in the receiving of the first and second sample images, a plurality of first and second images obtained by simultaneously imaging the object with the stereo camera configured of the first and second cameras are received, and the simultaneously imaged first and second sample images among the plurality of first and second images are selected and received.

12. The stereo camera image depth calculating method of claim 1, wherein the calculating of the disparities in respective points of the object in the reference direction is performed on the selected regions in the first and second sample images.

13. An electronic device comprising:
a user inputting unit receiving a plurality of first and second images simultaneously captured by a stereo camera;
a memory storing the received first and second images therein; and
a controlling unit selecting first and second sample images from among the first and second images, scanning the selected first and second sample images to calculate disparities in respective points of an object in a reference direction, and selecting a value equal to or smaller than a minimum value among the calculated disparities as a relative movement value.

14. The electronic device of claim 13, wherein the controlling unit selects regions of interest in the first and second images, relatively moves the regions of interest in the reference direction by the relative movement value so that the disparities are decreased, scans the relatively moved regions of interest to calculate corrected disparities in respective points in the reference direction, and adds the relative movement value to the corrected disparities to calculate original disparities in respective points.

15. The electronic device of claim 13, wherein the controlling unit relatively moves the first and second images in the reference direction by the relative movement value so that the disparities are decreased, scans a region in which the relatively moved first and second images are overlapped with each other in the reference direction to calculate corrected disparities in respective points in the reference direction, and adds the relative movement value to the corrected disparities to calculate original disparities in respective points.

16. The electronic device of claim 14, wherein the controlling unit calculates distances (depths) of respective points of the object using the calculated original disparities.

17. The electronic device of claim 16, further comprising an outputting unit outputting the depths of respective points calculated by the controlling unit.

18. The electronic device of claim 17, wherein the outputting unit is a display unit outputting a result on a screen.
